(19) United States
(12) Patent Application Publication
(10) Pub. No.: US 2020/0068589 A1
(43) Pub. Date: Feb. 27, 2020

(54) FIXED WIRELESS ACCESS AND SHORT-RANGE DEVICES COEXISTENCE

(71) Applicant: QUALCOMM Incorporated, San Diego, CA (US)

(72) Inventors: Lochan VERMA, San Diego, CA (US); George CHERIAN, San Diego, CA (US)

(21) Appl. No.: 16/109,709

(22) Filed: Aug. 22, 2018

(51) Int. Cl. H04W 72/12; H04L 5/14; H04W 72/04

(52) U.S. Cl. CPC H04W 72/12; H04L 5/1469; H04W 92/12; H04W 72/0446; H04W 72/0433

(57) ABSTRACT

In certain aspects, an apparatus includes a processing system configured to generate a first frame, wherein the first frame includes one or more parameters for a first time slot. The apparatus also includes an interface configured to output the first frame for transmission, and to obtain first data from a wireless node within the first time slot or output first data for transmission to the wireless node within the first time slot.

### FIELD

Certain aspects of the present disclosure generally relate to wireless communications and, more particularly, to facilitating concurrent transmissions by wireless nodes in a fixed wireless access network and short-range devices.

### BACKGROUND

A fixed wireless access network may provide wireless backhaul links that connect client nodes to a backbone network (e.g., the Internet) without requiring that wired infrastructure (e.g., optical fibers) physically reach the client nodes. Unlike normal WLAN which is mostly based on the listen before talk principle, wireless nodes in the fixed wireless access network typically transmit on scheduled time slots using time division duplexing (TDD) without checking first whether a wireless medium is free.

### SUMMARY

A first aspect relates to an apparatus for wireless communications. The apparatus includes a processing system configured to generate a first frame, wherein the first frame includes one or more parameters for a first time slot. The apparatus also includes an interface configured to output the first frame for transmission, and to obtain first data from a wireless node within the first time slot or output first data for transmission to the wireless node within the first time slot.

A second aspect relates to a method for wireless communications. The method includes generating a first frame, wherein the first frame includes one or more parameters for a first time slot. The method also includes outputting the first frame for transmission. The method further includes obtaining first data from a wireless node within the first time slot or outputting first data for transmission to the wireless node within the first time slot.

A third aspect relates to an apparatus for wireless communications. The apparatus includes means for generating a first frame, wherein the first frame includes one or more parameters for a first time slot. The apparatus also includes means for outputting the first frame for transmission. The apparatus further includes means for obtaining first data from a wireless node within the first time slot or outputting first data for transmission to the wireless node within the first time slot.

A fourth aspect relates to a computer readable medium. The computer readable medium comprises instructions stored thereon for generating a first frame, wherein the first frame includes one or more parameters for a first time slot. The computer readable medium also comprises instructions stored thereon for outputting the first frame for transmission. The computer readable medium further comprises instructions stored thereon for obtaining first data from a wireless node within the first time slot or outputting first data for transmission to the wireless node within the first time slot.

A fifth aspect relates to a wireless node. The wireless node includes a processing system configured to generate a first frame, wherein the first frame includes one or more parameters for a first time slot. The apparatus also includes a transmitter configured to output the first frame for transmission, and a receiver. The receiver is configured to receive first data from another wireless node within the first time slot or the transmitter is configured to transmit the first data to the other wireless node within the first time slot.

A sixth aspect relates to an apparatus for wireless communications. The apparatus includes an interface configured to obtain at least a portion of a first frame from a first wireless node, wherein the first frame includes one or more parameters for a first time slot. The apparatus also includes a processing system configured to determine whether to transmit first data within the first time slot based on the one or more parameters. The interface is configured to output the first data for transmission within the first time slot if the processing system determines to transmit the first data within the first time slot.

A seventh aspect relates to a method for wireless communications. The method includes obtaining at least a portion of a first frame from a first wireless node, wherein the first frame includes one or more parameters for a first time slot. The method also includes determining whether to transmit first data within the first time slot based on the one or more parameters, and outputting the first data for transmission within the first time slot if a determination is made to transmit the first data within the first time slot.

An eighth aspect relates to an apparatus for wireless communications. The apparatus includes means for obtaining at least a portion of a first frame from a first wireless node, wherein the first frame includes one or more parameters for a first time slot. The apparatus also includes means for determining whether to transmit first data within the first time slot based on the one or more parameters, and means for outputting the first data for transmission within the first time slot if a determination is made to transmit the first data within the first time slot.

A ninth aspect relates to a computer readable medium. The computer readable medium comprises instructions stored thereon for obtaining at least a portion of a first frame from a first wireless node, wherein the first frame includes one or more parameters for a first time slot. The computer readable medium also comprises instructions stored thereon for determining whether to transmit first data within the first time slot based on the one or more parameters, and outputting the first data for transmission within the first time slot if a determination is made to transmit the first data within the first time slot.

A tenth aspect relates to a wireless node. The wireless node includes a receiver configured to receive at least a portion of a first frame from a first wireless node, wherein the first frame includes one or more parameters for a first time slot. The wireless node also includes a processing system configured to determine whether to transmit first data within the first time slot based on the one or more parameters, and a transmitter configured to transmit the first data within the first time slot if the processing system determines to transmit the first data within the first time slot.

### BRIEF DESCRIPTION OF THE DRAWINGS

FIG. 1 illustrates an example of a fixed wireless access network in accordance with certain aspects of the present disclosure.

FIG. 2 is a block diagram of exemplary wireless nodes in accordance with certain aspects of the present disclosure.

FIG. 3 illustrates an example in which transmissions in a fixed wireless access network block short-range wireless devices from transmitting in accordance with certain aspects of the present disclosure.

FIG. 4 shows an example of a TDD slot schedule for a wireless node in the fixed wireless access network in accordance with certain aspects of the present disclosure.

FIG. 5 illustrates an example of a TDD slot schedule for a wireless node in a fixed wireless access network in accordance with certain aspects of the present disclosure.

FIG. 6 illustrates another example of a TDD slot schedule for a wireless node in a fixed wireless access network in accordance with certain aspects of the present disclosure.

FIG. 7 illustrates yet another example of a TDD slot schedule for a wireless node in a fixed wireless access network in accordance with certain aspects of the present disclosure.

FIG. 8A shows an example of an enhanced directional multi-gigabit (EDMG) frame in accordance with certain aspects of the present disclosure.

FIG. 8B shows an example of a modulation and coding scheme (MCS) field in the EDMG frame in accordance with certain aspects of the present disclosure.

FIG. 9 is a flowchart of a method for wireless communications in accordance with certain aspects of the present disclosure.

FIG. 10 is a flowchart of another method for wireless communications in accordance with certain aspects of the present disclosure.

FIG. 11 illustrates an exemplary device in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

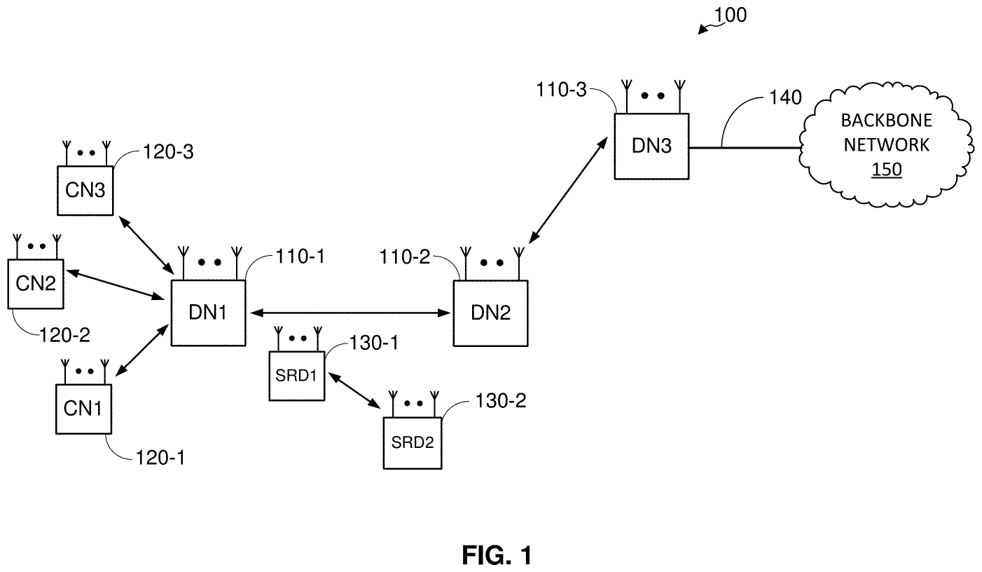

FIG. 1 illustrates an example of a fixed wireless access network 100 including wireless distribution nodes 110-1 to 110-3 (labeled “DN1” to “DN3”) and wireless client nodes 120-1 to 120-3 (labeled “CN1” to CN3”) distributed over a geographical area. The distribution nodes 110-1 to 110-3 provide the client nodes 120-1 to 120-3 (e.g., access points) with wireless backhaul links to a backbone network 150 (e.g., the Internet). For example, the client nodes 120-1 to 120-3 may access the backbone network 150 via a wireless backhaul link between distribution node 110-1 and distribution node 110-2, and a wireless backhaul link between distribution node 110-2 and distribution node 110-3. In this example, distribution node 110-3 is connected to the backbone network 150 via a wired infrastructure 140 (e.g., optical fiber, cable, etc.). Also, the client nodes 120-1 to 120-3 communicate directly with distribution node 110-1 through respective wireless links

Thus, in this example, data traffic between each client node 120-1 to 120-3 and the backbone network 150 travels through multiple distribution nodes 110-1 to 110-3. Each client node 120-1 to 120-3 may provide wireless network access to one or more wireless access terminals (not shown). The wireless access terminals may include smart phones, laptops, tablets, and/or any other devices having wireless connectivity capability.

The distribution nodes 110-1 to 110-3 may be deployed outdoors and/or indoors. For example, the distribution nodes 110-1 to 110-3 may be deployed outdoors in an urban environment to connect the client nodes 120-1 to 120-3 to the backbone network 150 without requiring the wired infrastructure 140 to physically reach each client node. In this example, each distribution node 110-1 to 110-3 may be mounted on a respective street fixture (e.g., street light post), the side of a respective building, etc. Each client node 120-1 to 120-3 may be mounted on a respective balcony, near a respective window, etc.

The distribution nodes 110-1 to 110-3 may transmit data traffic on scheduled time slots using time division duplexing (TDD) without checking whether a wireless medium is free, as discussed further below. The client nodes 120-1 to 120-3 may also transmit data traffic on scheduled slots using TDD without checking whether a wireless medium is free. Also, the distribution nodes 110-1 to 110-3 may be configured to use high directivity gain and narrow beams to form the links between the distribution nodes 110-1 to 110-3. The use of narrow beams extends the range of the distribution nodes 110-1 to 110-3 (e.g., greater than 50 meters). In certain aspects, the distribution nodes 110-1 to 110-3 may transmit data traffic in the millimeter wave (mmWave) band (e.g., 60 GHz band), e.g., for high throughput.

It is to be appreciated that the arrangement of the distribution nodes 110-1 to 110-3 shown in FIG. 1 is exemplary, and that the distribution nodes 110-1 to 110-3 may be arranged differently, e.g., depending on the topology of the environment (e.g., layout of street fixtures) in which the distribution nodes 110-1 to 110-3 are deployed. Also, it is to be appreciated that the fixed wireless access network 100 may include a larger number of distribution nodes than shown in FIG. 1, and that a distribution node may form links with more than two other distribution nodes. Further, it is to be appreciated that more than one distribution node in the fixed wireless access network 100 may service client nodes. For example, distribution node 110-2 may also service client nodes (not shown).

FIG. 1 also shows an example of short-range wireless devices 130-1 and 130-2 (labeled “SRD1” and “SRD2”) that operate in the same environment as the fixed wireless access network 100. Each short-range wireless device 130-1 and 130-2 may have relatively wider beams and lower directivity gains compared to the distribution nodes 110-1 to 110-3 and the client nodes 120-1 to 120-3. Each of the wireless devices 130-1 and 130-2 may be a mobile wireless device (e.g., smart phones, laptops, tablets, and/or any other mobile devices having wireless connectivity capability) that can move around in the environment (e.g., each wireless device may be nomadic). In contrast, each of the distribution nodes 110-1 to 110-3 may be fixed (e.g., mounted on a street fixture or the side of a building) and each of the client nodes 120-1 to 120-3 may be fixed. The wireless devices 130-1 and 130-2 may communicate with one another via a wireless link between the wireless devices 130-1 to 130-2, as shown in FIG. 1. The link between the wireless devices 130-1 and 130-2 may have a shorter range than the link between two distribution nodes 110-1 to 110-3 in the fixed wireless access network 100. For example, the link between the wireless devices 130-1 and 130-2 may have a range of less than 10 meters, while the link between two distribution nodes 110-1 and 110-3 in the fixed wireless access network 100 may have a range greater than 50 meters. The wireless devices 130-1 and 130-2 may use less directivity gain and wider beams for wireless communications than the distribution nodes 110-1 to 110-3.

The wireless devices 130-1 and 130-2 may reuse the same frequency band (e.g., mmWave band) as the distribution nodes 110-1 to 110-3 for wireless transmissions, which has the potential of causing interference between the wireless devices 130-1 and 130-2 and the fixed wireless access network 100. The potential for interference may be reduced by several factors. For example, the distribution nodes 110-1 to 110-3 may use narrow beams and may be mounted on top of street fixtures (e.g., street light posts) approximately 6 meters above ground. This reduces the likelihood of a wireless device 130-1 and 130-2 (which is typically held two meters or less above ground by a user) being within a coverage region of the distribution nodes 110-1 to 110-3.

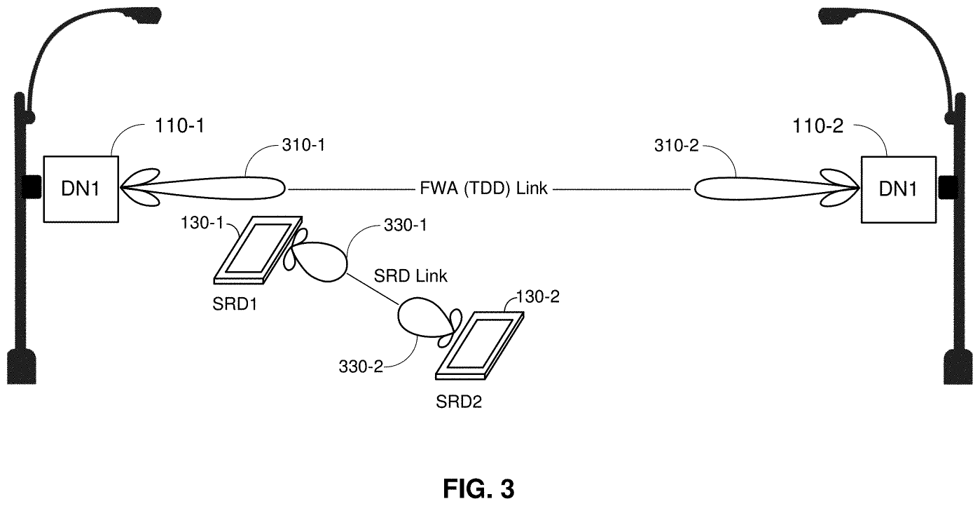

As discussed above, wireless medium access in the fixed wireless access network 100 may be scheduled and not based on a listen-before-talk scheme (e.g., carrier-sense multiple access with collision avoidance (CSMA/CA)). In this case, time may be divided into time slots, in which a distribution node 110-1 to 110-3 in the fixed wireless access network 100 either transmits or receives in a scheduled time slot without checking whether the wireless medium is free. In contrast, the wireless devices 130-1 and 130-3 may be CSMA/CA-based, in which a wireless device checks to see whether a wireless medium is free before transmitting on the wireless medium. A distribution node that transmits in a scheduled time slot can hog the wireless medium for the entire time slot and block a wireless device from transmitting on the wireless medium for the entire time slot. An example of this is discussed in detail below with reference to FIG. 3.

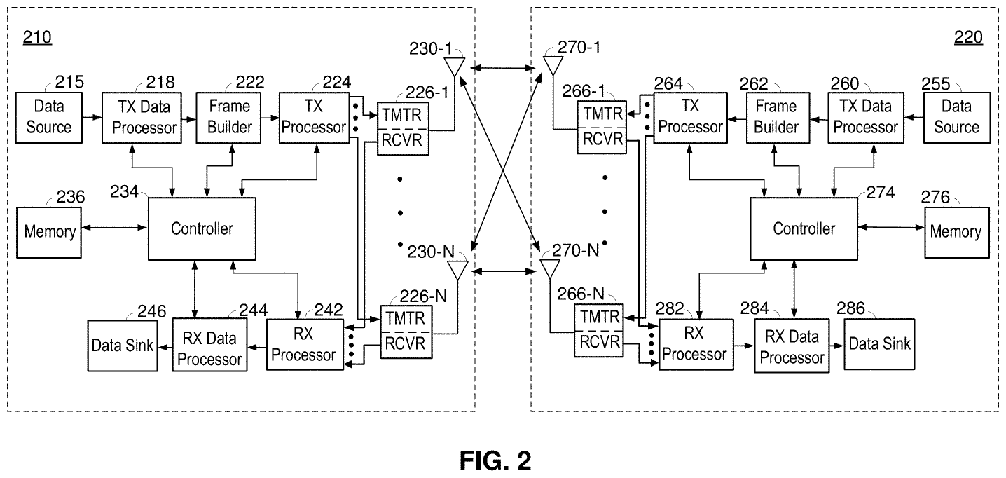

FIG. 2 illustrates a block diagram of a first wireless node 210 and a second wireless node 220 that communicate with one another via a wireless link In one example, the first and second wireless nodes 210 and 220 may be wireless nodes (e.g., distribution nodes 110-1 to 110-3) in the fixed wireless access network 100. In another example, the first and second wireless nodes 210 and 220 may be short-range wireless devices (e.g., short-range wireless devices 130-1 and 130-2). In yet another example, the first wireless node 210 may be a wireless node in the fixed wireless access network 100 and the second wireless node 220 may be a short-range wireless device.

For transmitting data, the first wireless node 210 includes a transmit data processor 218, a frame builder 222, a transmit processor 224, a plurality of transceivers 226-1 to 226-N, and a plurality of antennas 230-1 to 230-N. The first wireless node 210 also includes a controller 234 configured to control operations of the first wireless node 210, as discussed further below.

In operation, the transmit data processor 218 receives data (e.g., data bits) from a data source 215, and processes the data for transmission. For example, the transmit data processor 218 may encode the data (e.g., data bits) into encoded data, and modulate the encoded data into data symbols. The transmit data processor 218 may support different modulation and coding schemes (MCSs). For example, the transmit data processor 218 may encode the data (e.g., using low-density parity check (LDPC) encoding) at any one of a plurality of different coding rates. Also, the transmit data processor 218 may modulate the encoded data using any one of a plurality of different modulation schemes, including, but not limited to, BPSK, QPSK, 16QAM, 64QAM, 64APSK, 128APSK, 256QAM, and 256APSK. It is to be appreciated that the transmit data processor 218 may perform additional processing on the data such as data scrambling, and/or other processing. The transmit data processor 218 outputs the data symbols to the frame builder 222.

The frame builder 222 constructs a frame (also referred to as a packet), and inserts the data symbols into a data payload of the frame. Exemplary frame structures or formats are discussed further below. The frame builder 222 outputs the frame to the transmit processor 224. The transmit processor 224 processes the frame for transmission on the wireless link For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode.

In certain aspects, the transmit processor 224 may support multiple-output-multiple-input (MIMO) transmission. In these aspects, the first wireless node 210 includes multiple antennas 230-1 to 230-N and multiple transceivers 226-1 to 226-N (e.g., one for each antenna). The transmit processor 224 may perform spatial processing on the incoming frames and provide a plurality of transmit frame streams for the plurality of antennas. The transceivers 226-1 to 226-N receive and process (e.g., convert to analog, amplify, filter, and frequency upconvert) the respective transmit frame streams to generate transmit signals for transmission via the antennas 230-1 to 230-N. The transmit processor 224 may also perform beamforming by applying a weight vector to the signals output to the multiple antennas 230-1 to 230-N according to a desired beam direction (e.g., a direction pointing toward the second wireless node 220).

For transmitting data, the second wireless node 220 includes a transmit data processor 260, a frame builder 262, a transmit processor 264, a plurality of transceivers 266-1 to 266-N, and a plurality of antennas 270-1 to 270-N. The second wireless node 220 may transmit data to the first wireless node 210 via the wireless link The second wireless node 220 also includes a controller 274 configured to control operations of the second wireless node 220, as discussed further below.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. It is to be appreciated that the transmit data processor 260 may perform additional processing on the data. The transmit data processor 260 outputs the data symbols to the frame builder 262.

The frame builder 262 constructs a frame, and inserts the received data symbols into a data payload of the frame. Exemplary frame structures or formats are discussed further below. The frame builder 262 outputs the frame to the transmit processor 264. The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode.

In certain aspects, the transmit processor 264 may support multiple-output-multiple-input (MIMO) transmission. In these aspects, the second wireless node 220 includes multiple antennas 270-1 to 270-N and multiple transceivers 266-1 to 266-N (e.g., one for each antenna). The transmit processor 264 may perform spatial processing on the incoming frame and provide a plurality of transmit frame streams for the plurality of antennas. The transceivers 266-1 to 266-N receive and process (e.g., convert to analog, amplify, filter, and frequency upconvert) the respective transmit frame streams to generate transmit signals for transmission via the antennas 270-1 to 270-N. The transmit processor 264 may also perform beamforming by applying a weight vector to the signals output to the multiple antennas 270-1 to 270-N according to a desired beam direction (e.g., a direction pointing toward the first wireless node 210).

For receiving data, the first wireless node 210 includes a receive processor 242, and a receive data processor 244. In operation, the transceivers 226-1 to 226-N receive signals (e.g., from the second wireless node 220) via the antennas 230-1 to 230-N, and process (e.g., frequency downconvert, amplify, filter and convert to digital) the received signals.

The receive processor 242 receives the outputs of the transceivers 226-1 to 226-N, and processes the outputs to recover data symbols. The receive data processor 244 receives the data symbols from the receive processor 242. The receive data processor 244 may demodulate and decode the data symbols to recover data, and output the recovered data (e.g., data bits) to a data sink 246 for storage and/or further processing.

As discussed above, the second wireless node 220 may transmit data using an OFDM transmission mode or a SC transmission mode. In this case, the receive processor 242 may process the receive signal according to the selected transmission mode. Also, as discussed above, the transmit processor 264 may support multiple-output-multiple-input (MIMO) transmission. In this case, the first wireless node 210 includes multiple antennas 230-1 to 230-N and multiple transceivers 226-1 to 226-N (e.g., one for each antenna). Each transceiver receives and processes (e.g., frequency downconverts, amplifies, filters, and converts to digital) the signal from the respective antenna. The receive processor 242 may perform spatial processing on the outputs of the transceivers 226-1 to 226-N to recover the data symbols. The receive processor 242 may also perform beamforming by applying a weight vector to the signals received from the multiple antennas 230-1 to 230-N according to a desired beam direction (e.g., a direction pointing toward the second wireless node 220).

For receiving data, the second wireless node 220 includes a receive processor 282, and a receive data processor 284. In operation, the transceivers 266-1 to 266-N receive signals (e.g., from the first wireless node 210) via the antennas 270-1 to 270-N, and process (e.g., frequency downconvert, amplify, filter and convert to digital) the received signals.

The receive processor 282 receives the outputs of the transceivers 266-1 to 266-N, and processes the outputs to recover data symbols. The receive data processor 284 receives the data symbols from the receive processor 282. The receive data processor 284 may demodulate and decode the data symbols to recover data, and output the recovered data (e.g., data bits) to a data sink 286 for storage and/or further processing.

As discussed above, the first wireless node 210 may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the second wireless node 220 includes multiple antennas 270-1 to 270-N and multiple transceivers 266-1 to 266-N (e.g., one for each antenna). Each transceiver receives and processes (e.g., frequency downconverts, amplifies, filters, and converts to digital) the signal from the respective antenna. The receive processor 282 may perform spatial processing on the outputs of the transceivers to recover the data symbols. The receive processor 282 may also perform beamforming by applying a weight vector to the signals received from the multiple antennas 270-1 to 270-N according to a desired beam direction (e.g., a direction pointing toward the first wireless node 210).

As shown in FIG. 2, the first wireless node 210 also includes a memory 236 coupled to the controller 234. The memory 236 may store instructions that, when executed by the controller 234, cause the controller 234 to perform one or more of the operations described herein. Similarly, the second wireless node 220 also includes a memory 276 coupled to the controller 274. The memory 276 may store instructions that, when executed by the controller 274, cause the controller 274 to perform the one or more of the operations described herein.

As discussed above, the fixed wireless access network 100 can potentially block the wireless devices 130-1 and 130-2 from transmitting during certain time slots, starving the wireless devices 130-1 and 130-2 of transmit opportunities in these time slots. An example of this will now be discussed with reference to FIG. 3. In this example, distribution nodes 110-1 and 110-2 form a wireless backhaul link between the distribution nodes 110-1 and 110-2 using narrow beams 310-1 and 310-2. Also, in this example, time is divided into simplex time slots, in which transmissions between the distribution nodes 110-1 and 110-2 are in one direction in a time slot. Thus, in this example, a distribution node either transmits or receives in a time slot.

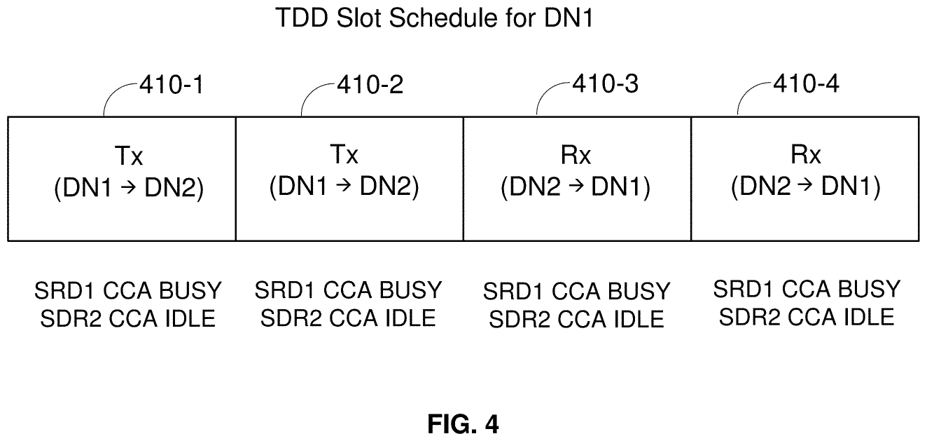

In this example, distribution nodes 110-1 and 110-2 transmit and receive over a wireless medium according to a time division duplex (TDD) slot schedule without having to check whether the wireless medium is free. In this regard, FIG. 4 shows an example of a TDD slot schedule for distribution node 110-1. In this example, distribution node 110-1 (labeled “DN1” in FIG. 4) transmits to distribution node 110-2 (labeled “DN2” in FIG. 4) in time slots 410-1 and 410-2, and distribution node 110-1 receives from distribution node 110-2 in time slots 410-3 and 410-4.

Referring back to FIG. 3, FIG. 3 shows an example in which the wireless devices 130-1 and 130-2 form a link for wireless communications between the wireless devices 130-1 and 130-2. In this example, the wireless devices 130-1 and 130-2 communicate with each other using less directivity gain and wider beams 330-1 and 330-2 than distribution nodes 110-1 and 110-2, as shown in FIG. 3. In this example, the wireless devices 130-1 and 130-2 communicate over a shorter distance than the distribution nodes 110-1 and 110-2.

In this example, each wireless device 130-1 and 130-2 employs CSMA/CA in which each wireless device 130-1 and 130-2 checks to see whether the wireless medium is free before transmitting over the wireless medium. In this regard, each wireless device 130-1 and 130-2 listens for a signal on the wireless medium (e.g., using quasi-omnidirectional sensing) before transmitting over the wireless medium. If the wireless device 130-1 and 130-2 detects a signal having a received signal strength above a clear channel assessment (CCA) threshold, then the wireless device 130-1 and 130-2 determines that the wireless medium is busy, and backs off from transmitting over the wireless medium for a back-off period. If the wireless device 130-1 and 130-2 does not detect a signal having a received signal strength above the CCA threshold, then the wireless device 130-1 and 130-2 may determine that the wireless medium is idle, and transmit over the wireless medium.

Referring back to FIG. 4, in the example shown in FIG. 4, wireless device 130-1 detects signals from distribution node 110-1 above the CCA threshold in time slots 410-1 and 410-2, and detects signals from distribution node 110-2 above the CCA threshold in time slots 410-3 and 410-4. As a result, wireless device 130-1 (labeled “SRD1” in FIG. 4) determines that the wireless medium is busy for all four time slots 410-1 to 410-4, and therefore does not transmit in all four time slots 410-1 and 410-4.

In this example, wireless device 130-2 (labeled “SRD2” in FIG. 4) does not detect signals above the CCA threshold in time slots 410-1 to 410-4 and may determine that the wireless medium is idle. However, transmissions by wireless device 130-2 may still be blocked. For example, the wireless devices 130-1 and 130-2 may exchange request-to-send (RTS) and clear-to-send (CTS) messages before transmitting data. In this example, wireless device 130-2 may send an RTS message to wireless device 130-1. Wireless device 130-1 does not send a CTS message to wireless device 130-2 in response to the RTS message since wireless device 130-1 determines that the wireless medium is busy. Thus, wireless device 130-2 is also blocked from transmitting in time slots 410-1 to 410-4 since the RTS/CTS exchange is not successful due to wireless device 130-1 detecting that the wireless medium is busy. Thus, in this example, both wireless devices 130-1 and 130-2 are starved for transmit opportunities in time slots 410-1 to 410-4.

To address this, the present disclosure provides various approaches for facilitating concurrent transmissions by short-range wireless devices (e.g., wireless devices 130-1 and 130-2) and wireless nodes (e.g., distribution nodes 110-1 to 110-3) in a fixed wireless access network. These approaches are discussed in detail below according to aspects of the present disclosure.

In one approach, wireless nodes (e.g., distribution nodes 110-1 to 110-3) in a fixed wireless access (FWA) network (e.g., FWA network 100) exchange concurrence request/response frames with one another in new TDD slots to assist short-range wireless devices (e.g., wireless devices 130-1 and 130-2) with transmissions that overlap fixed wireless access (FWA) transmissions. The concurrence request/response frames include parameters that assist a short-range wireless device in transmitting concurrently with an FWA transmission in a TDD slot. Examples of the parameters are provided below according to certain aspects of the present disclosure.

A short-range wireless device (e.g., one of wireless devices 130-1 and 130-2) hears (i.e., receives) concurrence request/response frames from the FWA network, and determines its transmission parameters for a concurrent transmission that overlaps with an FWA transmission based on the request/response frames. The short-range wireless device may perform the concurrent transmission even though the wireless medium is CCA busy from the wireless device's perspective.

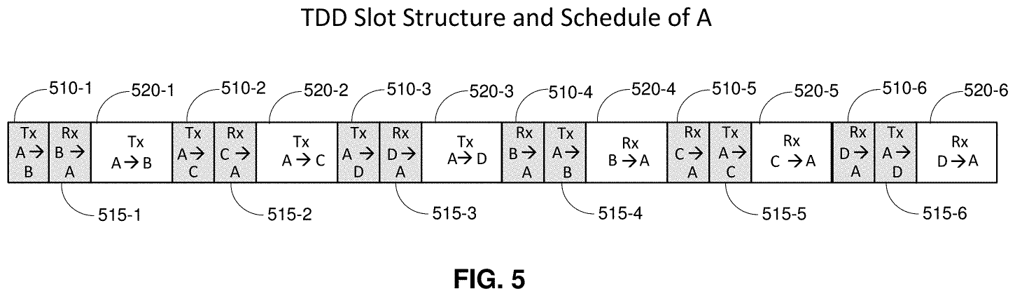

FIG. 5 shows an example of a schedule for request/response exchanges in an FWA network (e.g., FWA network 100) according to certain aspects of the present disclosure. The schedule is for a wireless node (labeled “A”) that communicates with three other wireless nodes (labeled “B” to “D”) in the FWA network. In the discussion below, these nodes are referred to as nodes A to nodes D. The labels “Tx” and “Rx” in FIG. 5 are with respect to node A. Therefore, the label “Tx” indicates that node A is the transmitting node in the corresponding time slot, and the label “Rx” indicates that node A is the receiving node in the corresponding time slot. In the example shown in FIG. 5, the time slots are simplex TDD slots, in which transmission between two nodes in each time slot is in one direction. Node A may be a distribution node (e.g., any one of distribution nodes 110-1 to 110-3).

In this example, the schedule for node A includes multiple transmission TDD slots 520-1 to 520-6. In each TDD slot 520-1 to 520-6, node A either transmits data to or receives data from one of nodes B to D. For example, in TDD slot 520-1, node A transmits data to node B. In TDD slot 520-4, node A receives data from node B. The transmission in each TDD slot 520-1 to 520-6 is over a wireless link (e.g., a wireless backhaul link) between node A and one of nodes B to D.

In the example shown in FIG. 5, each transmission TDD slot 520-1 to 520-6 is preceded by a concurrence request/response exchange. For example, transmission TDD slot 520-1 is preceded by a concurrence request/response exchange between node A and node B. In a concurrence request/response exchange preceding a transmission TDD slot, the transmitting node in the transmission TDD slot transmits a request frame and the receiving node in the transmission TDD slot transmits a response frame. For example, in the concurrence request/response exchange preceding transmission TDD slot 520-1, node A (i.e., the transmitting node in TDD slot 520-1) transmits a request frame, and node B (i.e., the receiving node in TDD slot 520-1) transmits a response frame. Each concurrence request/response exchange may be done over the same wireless link used for the data transmission in the corresponding TDD slot.

The schedule for node A includes new time slots 510-1 to 510-6 and 515-1 to 515-6 for the concurrence request/response exchanges. More particularly, time slots 510-1 to 510-6 are used for the request frames and time slots 515-1 to 515-6 are used for the response frames. As shown in FIG. 5, each transmission TDD slot 520-1 to 520-6 is preceded by two time slots for the corresponding concurrence request/response exchange. For example, transmission TDD slot 520-1 is preceded by time slots 510-1 and 515-1, in which node A transmits the corresponding request frame in time slot 510-1 and node B transmits the corresponding response frame in time slot 515-1.

For each TDD slot 520-1 to 520-6, the corresponding request frame and response frame each includes one or more parameters for assisting a short-range wireless device to perform a concurrent transmission that overlaps with an FWA transmission in the TDD slot. For example, for TDD slot 520-1, the corresponding request frame in time slot 510-1 and the corresponding response frame in time slot 515-1 each includes one or more parameters for assisting a short-range wireless device to transmit concurrently with an FWA transmission in TDD slot 520-1.

In this regard, a short-range wireless device (e.g., one of wireless devices 130-1 and 130-2) listens for request/response frames from the FWA network (e.g., FWA network). For example, the short-range wireless device may listen for request/response frames in a quasi-omnidirectional mode or a directional mode. Upon hearing (i.e., receiving) a request frame and/or response frame, the short-range wireless device retrieves one or more parameters from the request frame and/or response frame and uses the retrieved one or more parameters to determine its transmission parameters for a concurrent transmission that overlaps with an FWA transmission in the corresponding TDD slot 520-1 to 520-6. For example, upon hearing (i.e., receiving) the request frame and/or response frame for TDD slot 520-1, the short-range wireless device uses the one or more parameters in the request frame and/or response frame to determine its transmission parameters for a concurrent transmission that overlaps with an FWA transmission in TDD slot 520-1. The short-range wireless device may perform the concurrent transmission even though the wireless medium is CCA busy from the wireless device's perspective. Examples of parameters that may be included in a request frame and/or a response frame are discussed further below.

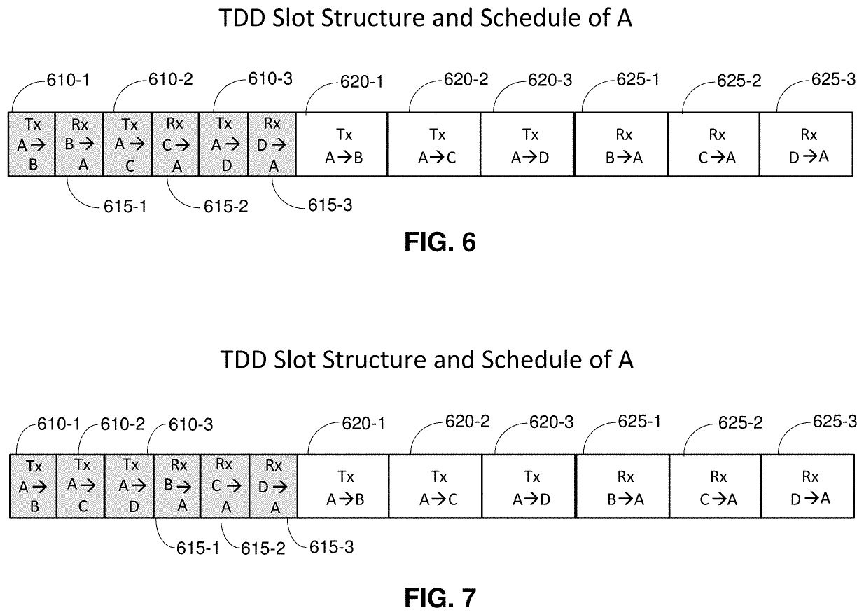

FIG. 6 shows another example of a schedule for node A according to certain aspects of the present disclosure. In this example, the schedule includes transmission TDD slots 620-1 to 620-3 for transmissions from node A, and transmission slots 625-1 to 625-3 for transmissions to node A. Thus, in each of TDD slots 620-1 to 620-3, node A is the transmitting node, and, in each of TDD slots 625-1 to 625-3, node A is the receiving node. In this example, the schedule includes two TDD slots for each pairing of node A with one of nodes B to D. More particularly, the schedule includes TDD slots 620-1 and 625-1 for nodes A and B, in which node A transmits to node B in TDD slot 620-1, and node B transmits to node A in TDD slot 625-1. The schedule also includes TDD slots 620-2 and 625-2 for nodes A and C, in which node A transmits to node C in TDD slot 620-2, and node C transmits to node A in TDD slot 625-2. The schedule also includes TDD slots 620-3 and 625-3 for nodes A and D, in which node A transmits to node D in TDD slot 620-3, and node D transmits to node A in TDD slot 625-3.

In this example, the schedule includes one request/response exchange for each pair of nodes. For nodes A and B, the schedule includes a request/response exchange in which the request frame is transmitted from node A to node B in time slot 610-1 and the response frame is transmitted from node B to node A in time slot 615-1. For nodes A and C, the schedule includes a request/response exchange in which the request frame is transmitted from node A to node C in time slot 610-2 and the response frame is transmitted from node C to node A in time slot 615-2. Lastly, for nodes A and D, the schedule includes a request/response exchange in which the request frame is transmitted from node A to node D in time slot 610-3 and the response frame is transmitted from node D to node A in time slot 615-2.

For each pair of nodes, the corresponding request frame and response frame each includes one or more parameters for assisting a short-range wireless device perform concurrent transmissions in the TDD slots for the pair of nodes. For example, for nodes A and B, the corresponding request frame and response frame transmitted in time slots 610-1 and 615-1, respectively, each includes one or more parameters for assisting a short-range wireless device perform concurrent transmissions in TDD slots 620-1 and 625-1. Similarly, for nodes A and C, the corresponding request frame and response frame transmitted in time slots 610-2 and 615-2, respectively, each includes one or more parameters for assisting a short-range wireless device perform concurrent transmissions in TDD slots 620-2 and 625-2. Lastly, for nodes A and D, the corresponding request frame and response frame transmitted in time slots 610-3 and 615-3, respectively, each includes one or more parameters for assisting a short-range wireless device perform concurrent transmissions in TDD slots 620-3 and 625-3. Examples of parameters that may be included in a request frame and/or a response frame are discussed further below.

In the example shown in FIG. 6, the request/response exchanges are all performed in a contiguous block of time before the data transmissions in the corresponding TDD slots 620-1 to 620-3 and 625-1 to 625-3. In this example, a short-range wireless device may listen for request and response frames during the block of time to gather information from the request and response frames, and use the information to perform concurrent transmissions in the corresponding TDD slots 620-1 to 620-3 and 625-1 to 625-3, as discussed further below.

The exemplary schedule in FIG. 6 reduces overhead with respect to the FWA network compared with the exemplary schedule in FIG. 5. This is because the schedule in FIG. 5 includes one request/response exchange for each TDD slot 520-1 to 520-6 while the schedule in FIG. 6 includes one request/response exchange for each pair of TDD slots 620-1 to 620-3 and 625-1 to 625-3 corresponding to a pair of nodes. Thus, the schedule in FIG. 6 has half the number of request/response exchanges as the schedule in FIG. 5 for the same number of TDD slots. Thus, the schedule in FIG. 6 reduces the overhead associated with the request/response exchanges by approximately half with respect to the FWA network compared with the schedule in FIG. 5.

FIG. 7 shows still another example of a schedule for node A according to certain aspects of the present disclosure. The schedule in FIG. 7 is similar to the schedule in FIG. 6 in that the request/response exchanges are all performed before the TDD slots 620-1 to 620-3 and 625-1 to 625-3. The schedule in FIG. 7 differs in that node A transmits all of the request frames consecutively before any of the response frames. After transmitting all of the request frames, node A receives all of the response frames consecutively. This implementation reduces latency at node A associated with switching node A between transmit mode and receive mode. This is because node A switches once from transmit mode to receive mode after transmitting all of the request frames. In contrast, for the schedule in FIG. 6, node A switches from transmit mode to receive mode after each request frame.

Examples of parameters that may be included in a request frame will now be discussed according certain aspects of the present disclosure.

A request frame may include an indicator indicating a start time of the time slot of the corresponding response frame. The indicator may be in the form of a time offset from a reference time (e.g., current time). The indicator may be used to assist a short-range wireless device receiving the request frame to receive the corresponding response frame (e.g., for the case where the request frame and the receive frame are separated in time by one or more time slots). For example, for the exemplary schedule in FIG. 7, the request frame in time slot 610-1 may include an indicator indicating the start time of time slot 615-1 for the corresponding response frame, in which the request frame and the corresponding response frame are separated in time by time slots 610-2 and 610-3.

The request frame may also include a first indicator indicating a start time of a corresponding TDD slot and a second indicator indicating a duration of the corresponding TDD slot. The first indicator may be in the form of a time offset from a reference time (e.g., current time). For example, with reference to FIG. 5, the request frame in time slot 510-1 may include a first indicator indicating the start time of TDD slot 520-1 and a second indicator indicating the duration of TDD slot 520-1. A short-range wireless device receiving the request frame may use this information to determine the start time and the duration of the corresponding TDD slot. This way, if the short-range wireless device determines to perform a concurrent transmission in the corresponding TDD slot, the short-range wireless device can perform the concurrent transmission within the corresponding TDD slot. In other words, the short-range wireless device may use the first indicator and the second indicator to determine the start time and end time of the corresponding TDD slot, and perform the concurrent transmission between the determined start time and the determined end time of the corresponding TDD slot.

In certain aspects, the request frame may indicate the start times and durations of more than one corresponding TDD slot. For instance, for the example in which a request/response exchange corresponds to two TDD slots, the request frame may indicate the start time and duration of each of the two TDD slots. For example, with reference to FIG. 6, the request frame in time slot 610-1 may indicate the start time and duration of TDD slot 620-1 and the start time and duration of TDD slot 625-1. This information may be used to assist a short-range wireless device receiving the request frame to determine the start times and end times of the corresponding TDD slots (e.g., for the case where the request frame is separated from the corresponding TDD slots by one or more time slots).

In another example, the request frame may indicate the start time and duration of one of two corresponding TDD slots with the corresponding response frame indicating the start time and the duration of the other one of the two corresponding TDD slots. In this example, the request frame may indicate the start time and duration for the corresponding TDD slot in which the node transmitting the request frame is the transmitting node. For instance, the request frame in time slot 610-1 (which is transmitted by node A) may indicate the start time and duration for TDD slot 620-1 in which node A is the transmitting node. Alternatively, the request frame may indicate the start time and duration for the corresponding TDD slot in which the node transmitting the request frame is the receiving node. For instance, the request frame in time slot 610-1 (which is transmitted by node A) may indicate the start time and duration for TDD slot 625-1 in which node A is the receiving node.

The request frame may also include one or more parameters that allow a short-range wireless device receiving the request frame to determine whether a transmission by the short-range wireless device would interfere with an FWA transmission in a TDD slot. For example, the one or more parameters may include an indicator indicating a transmit power at the node transmitting the request frame. The transmit power may be an average transmit power per 2.16 GHz bandwidth over all antennas used to transmit the request frame.

The one or more parameters may also include training sequences (e.g., Golay sequences) appended to the end of the request frame. In this example, the short-range wireless device receiving the request frame may measure the received signal strength of one or more of the training sequences. The short-range wireless device may then determine the signal path loss between the short-range wireless device and the node transmitting the request frame based on the received signal strength of the one or more training sequences and the transmit power of the node transmitting the request frame. For example, a larger difference between the received signal strength and the transmit power at the node transmitting the request frame may be indicative of a larger signal path loss.

The short-range wireless device may then use the determined signal path loss to determine an amount of interference that a transmission by the short-range wireless device to another short-range wireless device would cause at the node that transmitted the request frame. For example, using the principle of transmit/receive reciprocity, the short-range wireless device may assume that a transmission from the short-range wireless device to the node experiences approximately the same signal path loss as the transmission of the request frame from the node to the short-range wireless device. In this example, the short-range wireless device may estimate the amount of interference that a transmission by the short-range wireless device would cause at the node based on the transmit power at the short-range wireless device and the signal path loss between the short-range wireless device and the node.

After determining the amount of interference that the transmission would cause at the node, the short-range wireless device may compare the amount of interference at the node with an interference threshold. If the amount of interference at the node exceeds the interference threshold, then the short-range wireless device may determine not to perform the transmission in a TDD slot where the node is the receiving node. If, on the other hand, the amount of interference at the node is equal to or less than the interference threshold, then the short-range wireless device may determine to perform the transmission in the TDD slot where the node is the receiving node. For example, if the request frame is transmitted by node A in time slot 610-1 and the short-range wireless device determines that the amount of interference at node A exceeds the interference threshold, then the short-range wireless device may determine not to perform the transmission in TDD slot 625-1 where node A is the receiving node. If, on the other hand, the amount of interference at node A is equal to or less than the interface threshold, then the short-range wireless device may determine to perform the transmission in TDD slot 625-1.

In certain aspects, the one or more parameters in the request frame includes the interference threshold. The interference threshold may be a receive interference power per 2.16 GHz bandwidth averaged over all antennas used for reception at the node. In these aspects, the short-range wireless device retrieves the interference threshold from the request frame and compares the determined amount of interference with the retrieved interference threshold. In these aspects, the node transmitting the request frame may determine the interference threshold based on, for example, an amount of interference that the node can tolerate and still correctly decode a signal received from another node.

Thus, the request frame may include one or more parameters (e.g., one or more training sequences, transmit power, and interference threshold) that allow the short-range wireless device to determine whether a concurrent transmission in a TDD slot by the short-range wireless device would cause an excessive amount of interference at the receiving node in the TDD slot.

As discussed above, the short-range wireless device measures the received signal strength of the one or more training sequences to determine the signal path loss between the short-range wireless device and the node transmitting the request frame. In one example, the short-range wireless device may receive the one or more training sequences in a directional mode. In this example, the receive direction in the directional mode may point in the same direction as a transmit direction in which the short-range wireless device intends to perform a transmission to another short-range wireless device. This way, the short-range wireless device may more accurately estimate the amount of interference a transmission to the other short-range wireless device would cause at the node transmitting the request frame. In this example, the short-range wireless device may receive most of the request frame in a quasi-omnidirectional mode and switch to the directional mode to receive the one or more training sequences (which may be appended to the end of the request frame).

In one example, the request frame may include multiple training sequences appended to the end of the request frame. In this example, the short-range wireless device may perform a receive sector sweep during reception of the training sequences, in which the short-range wireless device may receive each training sequence in a different direction. In this example, the short-range wireless device may measure the received signal strength of each training sequence in each direction. The short-range wireless device may then use the measured received signal strength for each direction to determine an amount of interference a transmission in each direction would cause at the node transmitting the request frame. In this example, when the short-range wireless device needs to transmit data to another short-range wireless device in a particular direction, the short-range wireless device may determine an amount of interference that a transmission in that direction would cause at the node based on the measured received signal strength for that direction. The short-range wireless device may then compare the determined amount of interference with the interference threshold to determine whether to transmit in that direction during a TDD slot, as discussed above.

Examples of parameters that may be included in a response frame will now be discussed according certain aspects of the present disclosure. The parameters in the response frame may be similar to the parameters in the corresponding request frame, as discussed further below.

A response frame may include a first indicator indicating a start time of a corresponding TDD slot and a second indicator indicating a duration of the corresponding TDD slot. The first indicator may be in the form of a time offset from a reference time (e.g., current time). For example, with reference to FIG. 5, the response frame in time slot 515-1 may include a first indicator indicating the start time of TDD slot 520-1 and a second indicator indicating the duration of TDD slot 520-1. A short-range wireless device receiving the response frame may use this information to determine the start time and the duration of the corresponding TDD slot. This way, if the short-range wireless device determines to perform a concurrent transmission in the corresponding TDD slot, the short-range wireless device can perform the concurrent transmission within the corresponding TDD slot. In other words, the short-range wireless device may use the first indicator and the second indicator to determine the start time and end time of the corresponding TDD slot, and perform the concurrent transmission between the determined start time and the determined end time of the corresponding TDD slot.

In certain aspects, the response frame may indicate the start times and durations of more than one corresponding TDD slot. For instance, for the example in which a request/response exchange corresponds to two TDD slots, the response frame may indicate the start time and duration of each of the two TDD slots. In certain aspects, the corresponding request frame may also include this information. This information may be used to assist a short-range wireless device receiving the response frame to determine the start times and end times of the corresponding TDD slots.

In another example, the response frame may indicate the start time and duration of one of two corresponding TDD slots with the corresponding request frame indicating the start time and the duration of the other one of the two corresponding TDD slots. In this example, the response frame may indicate the start time and duration for the corresponding TDD slot in which the node transmitting the response frame is the transmitting node. Alternatively, the response frame may indicate the start time and duration for the corresponding TDD slot in which the node transmitting the response frame is the receiving node.

The response frame may also include one or more parameters that allow a short-range wireless device receiving the response frame to determine whether a transmission by the short-range wireless device would interfere with an FWA transmission in a TDD slot. For example, the one or more parameters may include an indicator indicating a transmit power at the node transmitting the response frame. The transmit power may be an average transmit power per 2.16 GHz bandwidth over all antennas used to transmit the response frame.

The one or more parameters may also include training sequences (e.g., Golay sequences) appended to the end of the response frame. In this example, the short-range wireless device receiving the response frame may measure the received signal strength of one or more of the training sequences. The short-range wireless device may then determine the signal path loss between the short-range wireless device and the node transmitting the response frame based on the received signal strength of the one or more training sequences and the indicated transmit power of the node transmitting the response frame.

The short-range wireless device may then use the determined signal path loss to determine an amount of interference that a transmission by the short-range wireless device to another short-range wireless device would cause at the node that transmitted the response frame. For example, using the principle of transmit/receive reciprocity, the short-range wireless device may assume that a transmission from the short-range wireless device to the node experiences approximately the same signal path loss as the transmission of the response frame from the node to the short-range wireless device. In this example, the short-range wireless device may estimate the amount of interference that a transmission by the short-range wireless device would cause at the node based on the transmit power at the short-range wireless device and the signal path loss between the short-range wireless device and the node.

After determining the amount of interference that the transmission would cause at the node, the short-range wireless device may compare the amount of interference at the node with an interference threshold. If the amount of interference at the node exceeds the interference threshold, then the short-range wireless device may determine not to perform the transmission in a TDD slot where the node is the receiving node. If, on the other hand, the amount of interference at the node is equal to or less than the interference threshold, then the short-range wireless device may determine to perform the transmission in the TDD slot where the node is the receiving node. For example, if the response frame is transmitted by node A in time slot 515-4 and the short-range wireless device determines that the amount of interference at node A exceeds the interference threshold, then the short-range wireless device may determine not to perform the transmission in TDD slot 520-4 where node A is the receiving node. If, on the other hand, the amount of interference at node A is equal to or less than the interface threshold, then the short-range wireless device may determine to perform the transmission in TDD slot 520-4.

In certain aspects, the one or more parameters in the response frame includes the interference threshold. The interference threshold may be a receive interference power per 2.16 GHz bandwidth averaged over all antennas used for reception at the node. In these aspects, the short-range wireless device retrieves the interference threshold from the response frame and compares the determined amount of interference with the retrieved interference threshold.

Thus, the response frame may include one or more parameters (e.g., one or more training sequences, transmit power, and interference threshold) that allow the short-range wireless device to determine whether a concurrent transmission in a TDD slot by the short-range wireless device would cause an excessive amount of interference at the receiving node in the TDD slot.

As discussed above, the short-range wireless device measures the received signal strength of the one or more training sequences in the response frame to determine the signal path loss between the short-range wireless device and the node transmitting the response frame. In one example, the short-range wireless device may receive the one or more training sequences in a directional mode. In this example, the receive direction in the directional mode may point in the same direction as a transmit direction in which the short-range wireless device intends to perform a transmission to another short-range wireless device. This way, the short-range wireless device may more accurately estimate the amount of interference a transmission to the other short-range wireless device would cause at the node transmitting the response frame. In this example, the short-range wireless device may receive most of the response frame in a quasi-omnidirectional mode and switch to the directional mode to receive the one or more training sequences (which may be appended to the end of the response frame).

In one example, the response frame may include multiple training sequences appended to the end of the response frame. In this example, the short-range wireless device may perform a receive sector sweep during reception of the training sequences, in which the short-range wireless device may receive each training sequence in a different direction. In this example, the short-range wireless device may measure the received signal strength of each training sequence in each direction. The short-range wireless device may then use the measured received signal strength for each direction to determine an amount of interference a transmission in each direction would cause at the node transmitting the response frame. In this example, when the short-range wireless device needs to transmit data to another short-range wireless device in a particular direction, the short-range wireless device may determine an amount of interference that a transmission in that direction would cause at the node based on the measured received signal strength for that direction. The short-range wireless device may then compare the determined amount of interference with the interference threshold to determine whether to transmit in that direction during a TDD slot, as discussed above.

In certain aspects, a short-range wireless device may receive all of the information it needs to perform a concurrent transmission in a TDD slot without having to receive both the corresponding request frame and the corresponding response frame. For example, for the exemplary schedule in FIG. 5, the short-range wireless device may receive all the information it needs to perform a concurrent transmission in a TDD slot from the corresponding response frame without having to receive the corresponding request frame. For example, for TDD slot 520-1, the corresponding response frame in time slot 515-1 may include one or more training sequences that allow the short-range wireless device to determine the amount of interference a concurrent transmission by the short-range wireless device would cause at the receiving node in TDD slot 520-1 (i.e., node B). Thus, in this example, the response frame may include all of the information the short-range wireless device needs to determine whether the concurrent transmission would cause excessive interference at the receiving node in the corresponding TDD slot. This may not be the case for the exemplary schedules in FIGS. 6 and 7 since these schedules include one request/response exchange for each pair of TDD slots corresponding to a pair of nodes instead of one request/response exchange for each TDD slot.

In certain aspects, a short-range wireless device may randomize channel access prior to starting a concurrent transmission. This may be done to avoid collisions with other short-range wireless devices. For example, multiple short-range wireless devices may decide to perform a concurrent transmission in a TDD slot. In this case, if the short-range wireless devices jump onto the channel at the same time, then their transmissions may collide. To reduce collisions, each short-range wireless device may generate a random back-off period (e.g., using a randomizing algorithm) and back-off its concurrent transmission for the random back-off period (i.e., wait for the back-off period before performing the concurrent transmission). Randomizing the back-off periods of the short-range wireless devices helps ensure that the short-range wireless devices have different back-off periods, thereby reducing collisions between the short-range wireless devices. Thus, once a short-range wireless device decides to perform a concurrent transmission in a TDD slot, the short-range wireless device may generate a random back-off period and back off its concurrent transmission for the random back-off period to reduce the chances of a collision with another short-range wireless device. The random back-off period may be shorter than the duration of the TDD slot.

In certain aspects, information for assisting a short-range wireless device perform a concurrent transmission may be included in a TDD frame transmitted in a TDD slot instead of in request/response frames. In one example, the information includes a first indicator indicating that the TDD frame is being transmitted in a TDD transmission and a second indicator indicating a remaining duration of the TDD slot. The information may be included (i.e., located) in a preamble of the TDD frame. The TDD frame may be transmitted from one wireless node (e.g., one of distribution nodes 110-1 and 110-2) to another wireless node (e.g., one of distribution nodes 110-1 and 110-2) in an FWA network over a wireless link (e.g., wireless backhaul link). The payload of the TDD frame may include data traffic.

In this example, a short-range wireless device may receive at least a portion of the TDD frame (e.g., the preamble of the frame) and retrieve the above information to determine whether to perform a concurrent transmission in the TDD slot. For example, the short-range wireless device may identify that the TDD frame is being transmitted in a TDD transmission based on the first indicator, and decide to perform a concurrent transmission based on the identification of the TDD transmission. The short-range wireless device may then determine the remaining duration of the TDD slot in which the TDD frame is being transmitted, and perform the concurrent transmission within the determined remaining duration so that the concurrent transmission is finished by the end of the TDD slot. This approach is optimistic in that it assumes that interference of the concurrent transmission at the receiving node of the TDD transmission is insignificant due to location, antenna, and/or range properties of the short-range wireless device.

The short-range wireless device may receive the TDD frame in a quasi-omnidirectional mode or a directional mode. Also, the short-range wireless device may perform the concurrent transmission even when the wireless medium is considered CCA busy due to the TDD transmission.

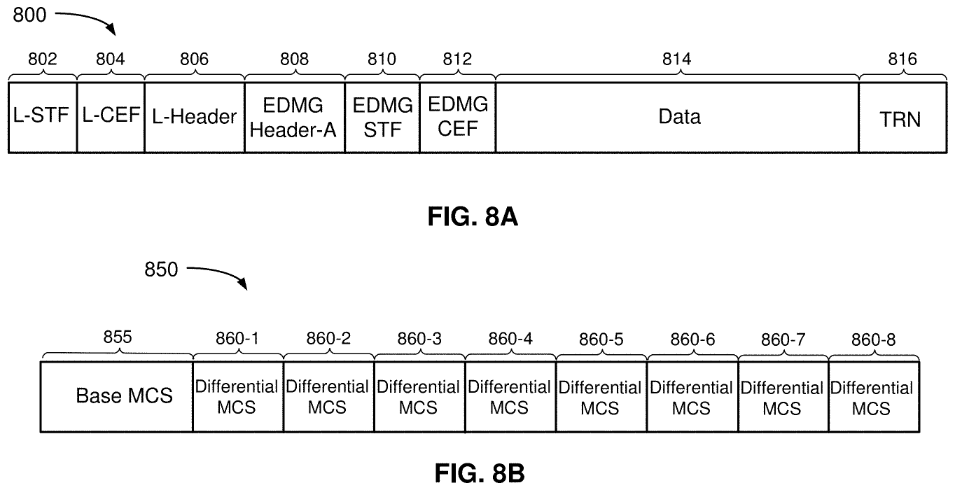

In certain aspects, the TDD frame is an enhanced directional multi-gigabit (EDMG) frame that is transmitted in the mmWave band. In this regard, FIG. 8A shows an example of a frame structure for an EDMG frame 800. The EDMG frame 800 may include a legacy STF (L-STF) 802, a legacy CEF (L-CEF) 804, and a legacy header (L-Header) according to a legacy standard (e.g., 802.11ad standard). The EDMG frame 800 may also include an EDMG Header-A 808, an EDGM STF 810, an EDMG CEF 812, a data payload 814, and a training field (TRN) 816. In this example, the first and second indicators discussed above may be inserted into an existing field of the EDMG frame 800 (i.e., the TDD frame in this example), in which the existing field is repurposed to include the first and second indicators. An example of a field that may be repurposed to include the first and second indicator will now be discussed according to aspects of the present disclosure.

The EDMG Header-A 808 of the EDMG frame 800 (i.e., the TDD frame in this example) includes a modulation and coding scheme (MCS) field 850 shown in FIG. 8B. The MCS field 850 includes a base MCS subfield 855 and eight differential MCS subfields 860-1 to 860-8. The base MCS subfield 855 indicates a base MCS and each of the differential MCS subfields 860-1 to 860-8 indicates a differential MCS for a respective spatial stream with respect to the base MCS. Since there are eight differential MCS subfields 860-1 to 860-8, the MCS field 850 is capable of providing differential MCSs for up to eight spatial streams. If a link uses less than eight spatial streams, then one or more of the MCS subfields 860-1 to 860-8 can be repurposed to include the first and second indictors.

For example, the links between wireless nodes (e.g., distribution nodes 110-1 to 110-3) in an FWA network (e.g., FWA network 100) may each use four or less spatial streams. In this example, at least four of the differential MCS subfields 860-1 to 860-8 in the EDMG frame 800 (i.e., the TDD frame in this example) can be repurposed to include the first and second indictors. Thus, the first and second indicators may be located in the repurposed differential MCS subfields 860-1 to 860-8. Since each differential MCS subfield has space for two bits, this example provides a space of at least eight bits for the first and second indicators.

In this example, the wireless node transmitting the EDMG frame 800 (i.e., the TDD frame in this example) may insert the first and second indicators in the repurposed differential MCS subfields. When a short-range wireless device receives a portion of the EDMG frame 800 (i.e., the TDD frame in this example), the short-range wireless device retrieves the first and second indicators from the repurposed differential MCS subfields, and performs a concurrent transmission within the corresponding TDD slot based on the retrieved first and second indicators, as discussed above.

As discussed above, the first indicator allows a short-range wireless device to identify a TDD transmission. In one example, the first indicator may comprise a TDD link color. In this example, each wireless link between two wireless nodes in an FWA network may be assigned a unique link color (e.g., number). In this example, link colors for the different links in the FWA network may be transmitted in a management frame or another frame. The short-range wireless device may receive the link colors (e.g., from the management frame) and use the link colors to identify a TDD transmission. For example, if the short-range wireless device receives a portion of a TDD frame, the short-range wireless device may retrieve the link color from the preamble and determine from the link color that the TDD frame is being transmitted over a link in the FWA network, and therefore that the TDD frame is being transmitted in a TDD transmission. In other words, the short-range wireless device can identify the TDD transmission based on the fact the TDD frame includes a link color.

In the above example, a short-range wireless device performs a concurrent transmission based on identification of a TDD transmission, in which the concurrent transmission is performed within the remaining duration of the corresponding TDD slot. In another example, the short-range wireless device may also estimate the interference that the concurrent transmission would cause at the receiving node of the TDD transmission, and make a determine whether to perform the concurrent transmission based also on the estimated interference, as discussed further below.

In this example, before the current TDD transmission, the short-range wireless device may obtain certain information about the two end nodes (e.g., distribution nodes 110-1 and 110-2) of the corresponding wireless link, as discussed further below. For example, before the current TDD transmission, the short-range wireless device may receive a prior frame from a first node of the wireless link, in which the prior frame includes training sequences (e.g., appended to the end of the prior frame). In this example, the short-range wireless device may perform a receive sector sweep during reception of the training sequences to determine a direction of the first node with respect to the short-range wireless device. The short-range wireless device may also determine interference that a transmission by the short-range wireless device would cause at the first node based on the received training sequences, as discussed above.

The short-range wireless device may also receive a prior frame from a second node of the wireless link, in which the prior frame includes training sequences (e.g., appended to the end of the prior frame). In this example, the short-range wireless device may perform a receive sector sweep during reception of the training sequences to determine a direction of the second node with respect to the short-range wireless device. The short-range wireless device may also determine interference that a transmission by the short-range wireless device would cause at the second node based on the received training sequences, as discussed above.

In the above example, the prior frames from the first and second nodes may each include the link color of the wireless link The link color allows the short-range wireless device to identify that the prior frames are from nodes of the wireless link. Also, the short-range wireless device may distinguish between the frame from the first node of the wireless link and the frame from the second node of the wireless link based on the directions at which the frames are received at the short-range wireless device. This is because the first and second nodes are at different directions with respect to the short-range wireless device.

Thus, based on the prior frames from the first and second nodes of the wireless link, the short-range wireless device is able to determine the direction of each of the nodes of the wireless link with respect to the short-range wireless device and estimate the interference that a transmission by the short-range wireless device would cause at each of the nodes of the wireless link.

In this example, when the short-range wireless device receives the preamble of the current TDD frame, the short-range wireless device may determine that the current TDD frame corresponds to the wireless link discussed above based on the link color in the TDD frame. The short-range wireless device may also determine which one of the first and second nodes of the wireless link is transmitting the TDD frame based on the direction at which the TDD frame is received at the short-range wireless device. After determining which one of the first and second nodes of the wireless link is the transmitting node, the short-range wireless device may determine that the other one of the first and second nodes of the wireless link is the receiving node for the TDD frame.

After identifying the receiving node, the short-range wireless device may compare the interference that a transmission by the short-range wireless device would cause at the receiving node of the TDD frame with an interference threshold. If the interference is equal to or less than the interference threshold, then the short-range wireless device may determine to perform a concurrent transmission within the remaining duration of the TDD slot corresponding to the TDD frame. As discussed above, the remaining duration of the TDD slot is indicated in the TDD frame. If, on the other hand, the interference exceeds the interference threshold, then the short-range wireless device may determine not to perform a concurrent transmission within the remaining duration of the TDD slot. Thus, in this example, the short-range wireless device ensures that the interference that it causes at the receiving node of the TDD transmission is under the interference threshold.

In the above example, the short-range wireless device may obtain information about the end nodes for multiple wireless links, where each wireless link is identified by its link color. The information for each end node may include the corresponding link color, the direction of the node with respect to the short-range wireless device and an amount of interference that a transmission by the short-range wireless device would cause at the node. The short-range wireless device may obtain this information by receiving frames from the nodes, as discussed above.

When the short-range wireless device receives a TDD frame, the short-range wireless device may determine the corresponding wireless link from the link color in the TDD frame. The short-range wireless device may then determine which of the two end nodes of the wireless link is the transmitting node and which of the two end nodes of the wireless link is the receiving node for the TDD frame based on the direction at which the TDD frame is received at the short-range wireless device. After determining the receiving node, the short-range wireless device may compare the amount of interference that would be caused by a transmission by the short-range wireless device at the receiving node with the interference threshold. The short-range wireless device may determine to transmit during the TDD slot if the amount of interference is equal to or less than the interference threshold, and determine not to transmit if the amount of interference exceeds the interference threshold. If the short-range wireless device decides to transmit within the TDD slot, the short-range wireless device transmits within the remaining duration of the TDD slot indicated in the TDD frame.

In the above example, the interference threshold may be a global threshold (i.e., not specific to a particular node). In this example, the short-range wireless device may receive the interference threshold in a management frame or another frame.

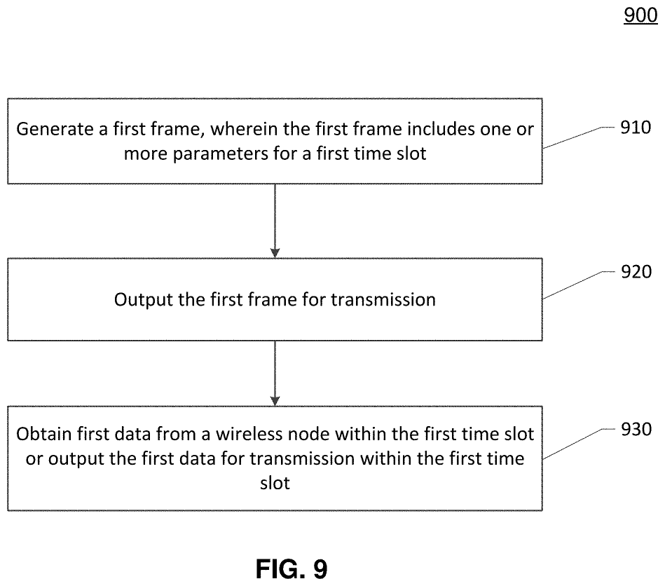

FIG. 9 is a flowchart illustrating a method 900 for wireless communications according to certain aspects of the present disclosure. The method 900 may be performed by a wireless node (e.g., one of the distribution nodes 110-1 to 110-3) in a fixed wireless access network.

At block 910, a first frame is generated, wherein the first frame includes one or more parameters for a first time slot. For example, the first frame may be a concurrence request frame, a concurrence response frame, or a TDD frame. The one or more parameters may include at least one of one or more training sequences, an interference threshold, or an indication of a transmit power. The one or more parameters may also include an indicator indicating a start time of the first time slot and an indicator indicating a duration of the first time slot. For the example in which the first frame is a TDD frame, the one or more parameters may include an indicator indicating a TDD transmission (e.g., link color) and an indicator indicating a remaining duration of the first time slot. The first time slot may be a time division duplex (TDD) slot.

At block 920, the first frame is output for transmission.

At block 930, first data is obtained from a wireless node within the first time slot or first data is output for transmission to the wireless node within the first time slot. The first data may be obtained or output for transmission via a wireless link (e.g., a wireless backhaul link) within the first time slot. For the example in which the first frame is a TDD frame, the first data may be inserted in the first frame (e.g., payload of the first frame) and the first frame may be output for transmission during the first time slot.

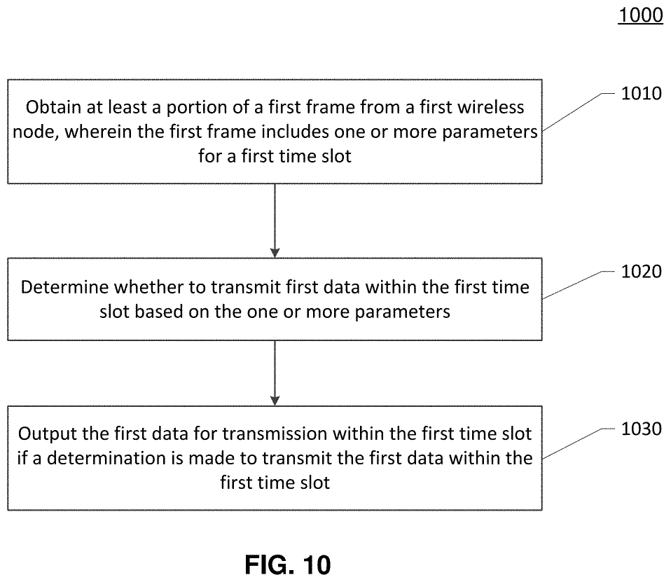

FIG. 10 is a flowchart illustrating a method 1000 for wireless communications according to certain aspects of the present disclosure. The method 1000 may be performed by a wireless device (e.g., one of the wireless devices 130-1 and 130-2).

At block 1010, at least a portion of a first frame is obtained from a first wireless node, wherein the first frame includes one or more parameters for a first time slot. The first wireless node may be a wireless node in a fixed wireless access network. The first frame may be a concurrence request frame, a concurrence response frame, or a TDD frame. The one or more parameters may include at least one of one or more training sequences, an interference threshold, or an indication of a transmit power. The one or more parameters may also include an indicator indicating a start time of the first time slot and an indicator indicating a duration of the first time slot. For the example in which the first frame is a TDD frame, the one or more parameters may include an indicator indicating a TDD transmission (e.g., link color) and an indicator indicating a remaining duration of the first time slot. The first time slot may be a time division duplex (TDD) slot.

At block 1020, a determination is made whether to transmit first data within the first time slot based on the one or more parameters.

At block 1030, the first data is output for transmission within the first time slot if a determination is made to transmit the first data within the first time slot.

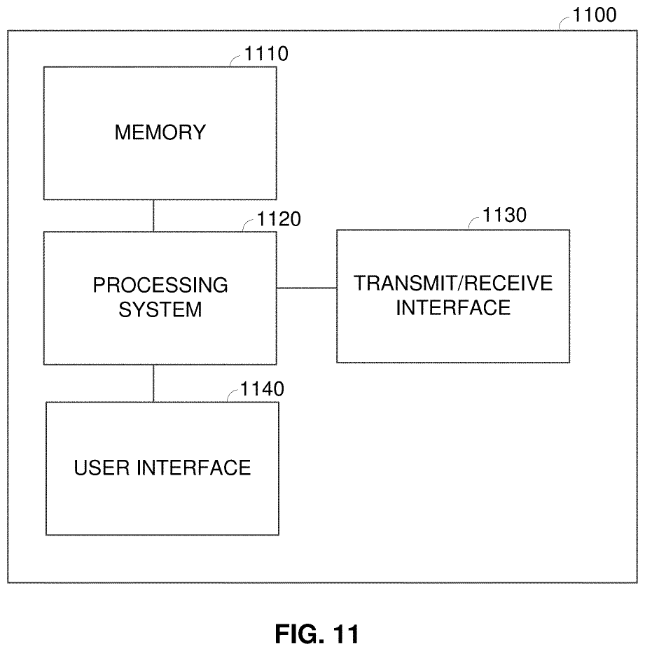

FIG. 11 illustrates an example device 1100 according to certain aspects of the present disclosure. The device 1100 may be configured to operate in a wireless node (e.g., wireless node 210 or 220) and to perform one or more of the operations described herein. For example, the device 1100 may operate in one of the distribution nodes 110-1 to 110-3 or one of the wireless devices 130-1 and 130-2 discussed above and perform one or more of the operations described herein.

The device 1100 includes a processing system 1120, and a memory 1110 coupled to the processing system 1120. The memory 1110 may store instructions that, when executed by the processing system 1120, cause the processing system 1120 to perform one or more of the operations described herein. Exemplary implementations of the processing system 1120 are provided below. The device 1100 also comprises a transmit/receive interface 1130 coupled to the processing system 1120. The transmit/receive interface 1130 (e.g., interface bus) may be configured to interface the processing system 1620 to a radio frequency (RF) front end (e.g., transceivers 226-1 to 226-N or 226-1 to 266-N).

In certain aspects, the processing system 1120 may include one or more of the following: a transmit data processor (e.g., transmit data processor 218 or 260), a frame builder (e.g., frame builder 222 or 262), a transmit processor (e.g., transmit processor 224 or 264) and/or a controller (e.g., controller 234 or 274) for performing one or more of the operations described herein.

In the case of wireless device (e.g., one of wireless devices 130-1 and 130-2), the device 1100 may include a user interface 1140 coupled to the processing system 1120. The user interface 1140 may be configured to receive data from a user (e.g., via keypad, mouse, joystick, etc.) and provide the data to the processing system 1120. The user interface 1140 may also be configured to output data from the processing system 1120 to the user (e.g., via a display, speaker, etc.). In this case, the data may undergo additional processing before being output to the user. In the case of a distribution node, the user interface 1140 may be omitted.

Examples of means for generating a first frame, wherein the first frame includes one or more parameters for a first time slot may include at least one of the controller 234 or 274, the frame builder 222 or 262, or the processing system 1120. Examples of means for outputting the first frame for transmission may include at least one of the transmit processor 224 or 264, the transceivers 226-1 to 226-N or 266-1 to 266-N, or the transmit/receive interface 1130. Examples of means for obtaining first data from a wireless node within the first time slot or outputting first data for transmission to the wireless node within the first time slot may include at least one of the transmit processor 224 or 264, the receive processor 242 or 282, the transceivers 226-1 to 226-N or 266-1 to 266-N, or the transmit/receive interface 1130. Examples of means for obtaining a second frame from the wireless node in response to the first frame may include at least one of the receive processor 242 or 282, the transceivers 226-1 to 226-N or 266-1 to 266-N, or the transmit/receive interface 1130. Examples of means for obtaining the second frame from the wireless node at the start time may include at least one of the receive processor 242 or 282, the transceivers 226-1 to 226-N or 266-1 to 266-N, or the transmit/receive interface 1130. Examples of means for obtaining second data from the wireless node within the second time slot or outputting second data for transmission to the wireless node within the second time slot may include at least one of the transmit processor 224 or 264, the receive processor 242 or 282, the transceivers 226-1 to 226-N or 266-1 to 266-N, or the transmit/receive interface 1130. Examples of means for inserting the first data in the first frame may include at least one of the controller 234 or 274, the frame builder 222 or 262, or the processing system 1120. Examples of means for outputting the first data for transmission to the wireless node in the first frame may include at least one of the transmit processor 224 or 264, the transceivers 226-1 to 226-N or 266-1 to 266-N, or the transmit/receive interface 1130.

Examples of means for obtaining at least a portion of a first frame from a first wireless node, wherein the first frame includes one or more parameters for a first time slot may include at least one of the receive processor 242 or 282, the transceivers 226-1 to 226-N or 266-1 to 266-N, or the transmit/receive interface 1130. Examples of means for determining whether to transmit first data within the first time slot based on the one or more parameters may include at least one of the controller 234 or 274, or the processing system 1120. Examples of means for outputting the first data for transmission within the first time slot if a determination is made to transmit the first data within the first time slot may include at least one of the transmit processor 224 or 264, the transceivers 226-1 to 226-N or 266-1 to 266-N, or the transmit/receive interface 1130. Examples of means for measuring a received signal strength of the one or more training sequences include may at least one of the controller 234 or 274, the processing system 1120, the transmit processor 224 or 264, the transceivers 226-1 to 226-N or 266-1 to 266-N, or the transmit/receive interface 1130. Examples of means for determining an amount of interference that transmission of the first data would cause at the first wireless node during the first time slot based on the received signal strength may include at least one of the controller 234 or 274, or the processing system 1120. Examples of means for comparing the determined amount of interference with the interference threshold may include at least one of the controller 234 or 274, or the processing system 1120. Examples of means for determining to transmit the first data within the first time slot if the determined amount of interference is equal to or less than the interference threshold may include at least one of the controller 234 or 274, or the processing system 1120. Examples of means for determining not to transmit the first data within the first time slot if the determined amount of interference exceeds the interference threshold may include at least one of the controller 234 or 274, or the processing system 1120. Examples of means for determining a signal path loss between the first wireless node and the apparatus based on the indicated transmit power and the received signal strength may include at least one of the controller 234 or 274, or the processing system 1120. Examples of means for determining the amount of interference based on the determined signal path loss may include at least one of the controller 234 or 274, or the processing system 1120. Examples of means for determining the start time of the first time slot based on the indicator may include at least one of the controller 234 or 274, or the processing system 1120. Examples of means for outputting the first data for transmission after the determined start time of the first time slot may include at least one of the transmit processor 224 or 264, the transceivers 226-1 to 226-N or 266-1 to 266-N, or the transmit/receive interface 1130. Examples of means for determining the time duration of the first time slot based on the indicator may include at least one of the controller 234 or 274, or the processing system 1120. Examples of means for outputting the first data for transmission within the determined time duration of the first time slot may include at least one of the transmit processor 224 or 264, the transceivers 226-1 to 226-N or 266-1 to 266-N, or the transmit/receive interface 1130. Examples of means for obtaining at least a portion of a second frame from a second wireless node, wherein the second frame includes one or more parameters for a second time slot include at least one of the receive processor 242 or 282, the transceivers 226-1 to 226-N or 266-1 to 266-N, or the transmit/receive interface 1130. Examples of means for determining whether to transmit second data within the second time slot based on the one or more parameters for the second time slot may include at least one of the controller 234 or 274, or the processing system 1120. Examples means for outputting the second data for transmission within the second time slot if a determination is made to transmit the second data within the second time slot may include at least one of the transmit processor 224 or 264, the transceivers 226-1 to 226-N or 266-1 to 266-N, or the transmit/receive interface 1130. Examples of means for determining the start time of the second frame based on the indicator may include at least one of the controller 234 or 274, or the processing system 1120. Examples of means for obtaining the second frame from the second wireless node based on the determined start time may include at least one of the receive processor 242 or 282, the transceivers 226-1 to 226-N or 266-1 to 266-N, or the transmit/receive interface 1130. Examples of means for determining the start time of the second time slot based on the indicator may include at least one of the controller 234 or 274, or the processing system 1120. Examples of means for outputting the second data for transmission after the determined start time of the second time slot may include at least one of the transmit processor 224 or 264, the transceivers 226-1 to 226-N or 266-1 to 266-N, or the transmit/receive interface 1130. Examples of means for determining the time duration of the second time slot based on the indicator may include at least one of the controller 234 or 274, or the processing system 1120. Examples of means for outputting the second data for transmission within the determined time duration of the second time slot may include at least one of the transmit processor 224 or 264, the transceivers 226-1 to 226-N or 266-1 to 266-N, or the transmit/receive interface 1130. Examples of means for generating a random back-off period may include at least one of the controller 234 or 274, or the processing system 1120. Examples of means for waiting for the random back-off period before outputting the first data for transmission within the first time slot may include at least one of the transmit processor 224 or 264, the transceivers 226-1 to 226-N or 266-1 to 266-N, or the transmit/receive interface 1130. Examples of means for obtaining the at least the portion of the first frame during the first time slot may include at least one of the receive processor 242 or 282, the transceivers 226-1 to 226-N or 266-1 to 266-N, or the transmit/receive interface 1130. Examples of means for determining to transmit the first data within the first time slot based on the indictor indicating that the first frame is being transmitted in the TDD transmission may include at least one of the controller 234 or 274, or the processing system 1120. Examples of means for determining the remaining time duration of the first time slot based on the indication of the remaining time duration of the first time slot may include at least one of the controller 234 or 274, or the processing system 1120. Examples of means for outputting the first data for transmission within the determined remaining time duration of the first time slot may include at least one of the transmit processor 224 or 264, the transceivers 226-1 to 226-N or 266-1 to 266-N, or the transmit/receive interface 1130. Examples of means for obtaining a signal from a second wireless node may include at least one of the receive processor 242 or 282, the transceivers 226-1 to 226-N or 266-1 to 266-N, or the transmit/receive interface 1130. Examples of means for measuring a received signal strength of the signal from the second wireless node may include at least one of the controller 234 or 247, the processing system 1120, the receive processor 242 or 282, the transceivers 226-1 to 226-N or 266-1 to 266-N, or the transmit/receive interface 1130. Examples of means for determining an amount of interference that transmission of the data would cause at the second wireless node based on the received signal strength may include at least one of the controller 234 or 274, or the processing system 1120. Examples means for measuring the received signal strength of a portion of the signal comprising the one or more training sequences may include at least one of the controller 234 or 247, the processing system 1120, the receive processor 242 or 282, the transceivers 226-1 to 226-N or 266-1 to 266-N, or the transmit/receive interface 1130. Examples of means for comparing the determined amount of interference with an interference threshold may include at least one of the controller 234 or 274, or the processing system 1120. Examples of means for determining not to transmit the first data within the first time slot if the determined amount of interference exceeds the interference threshold may include at least one of the controller 234 or 274, or the processing system 1120.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system (e.g., the processing system 1120) in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a wireless device, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a processing system configured to generate a first frame, wherein the first frame includes one or more parameters for a first time slot; and
an interface configured to:
output the first frame for transmission; and
obtain first data from a wireless node within the first time slot or output first data for transmission to the wireless node within the first time slot.

2. The apparatus of claim 1, wherein the one or more parameters include at least one of one or more training sequences, an interference threshold, or an indication of a transmit power at the apparatus.

3. The apparatus of claim 1, wherein the one or more parameters include an indicator indicating a start time of the first time slot.

4. (canceled)

5. The apparatus of claim 3, wherein the start time of the first time slot is separated from transmission of the first frame by one or more time slots.

6. (canceled)

7. The apparatus of claim 1, wherein the interface is configured to obtain a second frame from the wireless node in response to the first frame.

8. The apparatus of claim 7, wherein:
the first frame includes an indicator indicating a start time for the second frame; and
the interface is configured to obtain the second frame from the wireless node at the start time.

9. (canceled)

10. (canceled)

11. The apparatus of claim 7, wherein:
the second frame includes one or more parameters for a second time slot; and
the interface is configured to:
obtain second data from the wireless node within the second time slot or output second data for transmission to the wireless node within the second time slot.

12. The apparatus of claim 11, wherein the one or more parameters for the second time slot include at least one of one or more training sequences, an interference threshold, or an indication of a transmit power at the wireless node.

13. (canceled)

14. The apparatus of claim 1, wherein:
the processing system is configured to insert the first data in the first frame; and
the interface is configured to output the first data for transmission to the wireless node in the first frame.

15. The apparatus of claim 14, wherein the one or more parameters include at least one of a first indicator indicating a time division duplex (TDD) transmission, or a second indicator indicating a remaining duration of the first time slot.

16. (canceled)

17. The apparatus of claim 1, wherein:
the first frame includes a modulation and coding scheme (MCS) field;
the MCS field includes a plurality of differential MCS subfields; and
the one or more parameters are located in one or more of the plurality of differential MCS subfields.

18.-52. (Canceled)

53. A wireless node, comprising:
a processing system configured to generate a first frame, wherein the first frame includes one or more parameters for a first time slot;
a transmitter configured to output the first frame for transmission; and
a receiver;
wherein the receiver is configured to receive first data from another wireless node within the first time slot or the transmitter is configured to transmit the first data to the other wireless node within the first time slot.

54. An apparatus for wireless communications, comprising:
an interface configured to obtain at least a portion of a first frame from a first wireless node, wherein the first frame includes one or more parameters for a first time slot; and
a processing system configured to determine whether to transmit first data within the first time slot based on the one or more parameters;
wherein the interface is configured to output the first data for transmission within the first time slot if the processing system determines to transmit the first data within the first time slot.

55. The apparatus of claim 54, wherein:
the one or more parameters include one or more training sequences;
the processing system is configured to measure a received signal strength of the one or more training sequences;
the processing system is configured to determine an amount of interference that transmission of the first data would cause at the first wireless node during the first time slot based on the received signal strength; and
the processing system is configured to determine whether to transmit the first data within the first time slot based on the determined amount of interference.

56. The apparatus of claim 55, wherein:
the one or more parameters include an interference threshold; and
the processing system is configured to determine whether to transmit the first data within the first time slot by:
comparing the determined amount of interference with the interference threshold;
determining to transmit the first data within the first time slot if the determined amount of interference is equal to or less than the interference threshold; and
determining not to transmit the first data within the first time slot if the determined amount of interference exceeds the interference threshold.

57. The apparatus of claim 55, wherein:
the one or more parameters include an indication of a transmit power at the first wireless node; and
the processing system is configured to determine the amount of interference by:
determining a signal path loss between the first wireless node and the apparatus based on the indicated transmit power and the received signal strength; and
determining the amount of interference based on the determined signal path loss.

58. The apparatus of claim 54, wherein:
the one or more parameters include an indicator indicating a start time of the first time slot;
the processing system is configured to determine the start time of the first time slot based on the indicator; and
wherein the interface is configured to output the first data for transmission after the determined start time of the first time slot if the processing system determines to transmit the first data within the first time slot.

59. (canceled)

60. (canceled)

61. The apparatus of claim 54, wherein:
the one or more parameters include an indicator indicating a time duration of the first time slot;
the processing system is configured to determine the time duration of the first time slot based on the indicator; and
wherein the interface is configured to output the first data for transmission within the determined time duration of the first time slot if the processing system determines to transmit the first data within the first time slot.

62. The apparatus of claim 54, wherein:
the interface is configured to obtain at least a portion of a second frame from a second wireless node, wherein the second frame includes one or more parameters for a second time slot;
the processing system is configured to determine whether to transmit second data within the second time slot based on the one or more parameters for the second time slot; and
wherein the interface is configured to output the second data for transmission within the second time slot if the processing system determines to transmit the second data within the second time slot.

63. The apparatus of claim 62, wherein:
the first frame includes an indicator indicating a start time of the second frame;
the processing system is configured to determine the start time of the second frame based on the indicator; and
the interface is configured to obtain the second frame from the second wireless node based on the determined start time.

64. (canceled)

65. (canceled)

66. The apparatus of claim 62, wherein:
the one or more parameters for the second time slot include an indicator indicating a start time of the second time slot;
the processing system is configured to determine the start time of the second time slot based on the indicator; and
wherein the interface is configured to output the second data for transmission after the determined start time of the second time slot if the processing system determines to transmit the second data within the second time slot.

67. The apparatus of claim 62, wherein:
the one or more parameters for the second time slot include an indicator indicating a time duration of the second time slot;
the processing system is configured to determine the time duration of the second time slot based on the indicator; and
wherein the interface is configured to output the second data for transmission within the determined time duration of the second time slot if the processing system determines to transmit the second data within the second time slot.

68. The apparatus of claim 54, wherein:
the processing system is configured to generate a random back-off period; and
the interface is configured to wait for the random back-off period before outputting the first data for transmission within the first time slot if the processing system determines to transmit the first data within the first time slot.

69. The apparatus of claim 54, wherein the interface is configured to obtain the at least the portion of the first frame during the first time slot.

70. The apparatus of claim 69, wherein:
the one or more parameters includes an indicator indicating that the first frame is being transmitted in a time division duplex (TDD) transmission; and
the processing system is configured to determine to transmit the first data within the first time slot based on the indictor indicating that the first frame is being transmitted in the TDD transmission.

71. The apparatus of claim 54, wherein:
the one or more parameters include an indication of a remaining time duration of the first time slot;
the processing system is configured to determine the remaining time duration of the first time slot based on the indication of the remaining time duration of the first time slot; and
wherein the interface is configured to output the first data for transmission within the determined remaining time duration of the first time slot if the processing system determines to transmit the first data within the first time slot.

72. (canceled)

73. The apparatus of claim 54, wherein:
the frame includes a modulation and coding scheme (MCS) field;
the MCS field includes a plurality of differential MCS subfields; and
the one or more parameters are located in one or more of the plurality of differential MCS subfields.

74. The apparatus of claim 54, wherein:
the interface is configured to obtain a signal from a second wireless node;
the processing system is configured to measure a received signal strength of the signal from the second wireless node;
the processing system is configured to determine an amount of interference that transmission of the data would cause at the second wireless node based on the received signal strength; and
the processing system is configured to determine whether to transmit the first data within the first time slot based also on the determined amount of interference.

75. The apparatus of claim 74, wherein:
the signal from the second wireless node comprises one or more training sequences; and
the processing system is configured to measure the received signal strength of the signal by measuring the received signal strength of a portion of the signal comprising the one or more training sequences.

76.-124. (Canceled)

125. The apparatus of claim 54, further comprising a receiver configured to receive the at least the portion of the first frame from the first wireless node, wherein the apparatus is configured as another wireless node.
